(19) United States
(12) Patent Application Publication
(10) Pub. No.: US 2007/0139653 A1
(43) Pub. Date: Jun. 21, 2007

(54) MEMS Micromirror Surface Plasmon Resonance Biosensor and Method

(76) Inventors: Hann Wen Guan, Bothell, WA (US); Shuxin Cong, Lynnwood, WA (US); Minhua Liang, Bothell, WA (US); Eric Johnson, Minneapolis, MN (US)

Correspondence Address: FISH & RICHARDSON P.C., PO BOX 1022, MINNEAPOLIS, MN, 55440-1022, US

(21) Appl. No.: 11/422,698

(22) Filed: Jun. 7, 2006

Related U.S. Application Data
(60) Provisional application No. 60/687,964, filed on Jun. 7, 2005.

(51) Int. Cl. G01N 21/55

(52) U.S. Cl. 356/445

(57) ABSTRACT

A method of generating surface plasmon resonance using excitation light directed at a thin metal film by a micromirror is described. A method that uses excitation light directed at a thin metal film by a micromirror scanner device is also described. A surface plasmon resonance imager is described comprising a micromirror that directs light to the surface of a thin metal film. Another method is described, comprising: a) directing light toward a thin metal film using a micromirror and b) detecting dynamic chemical events at or near the surface of the thin metal film. The dynamic events may be, for example, a fluidic change or a binding event.

### RELATED APPLICATIONS

This application claims the benefit of priority under 35 U.S.C. §119(e)(1) to U.S. provisional application 60/687,964, filed Jun. 7, 2005.

### BACKGROUND

All patents, patent applications, and publications cited within this application are incorporated herein by reference to the same extent as if each individual patent, patent application, or publication was specifically and individually incorporated by reference.

The invention relates to detecting molecular binding events as well as photochemical spectral emission and/or absorption in a two-dimensionally discriminated manner such as, for example, in an array. The observation of molecular binding and affinity is a key element in biochemical and pharmaceutical research and development and analytical assays. In this field, the use of arrays is desirable in order to increase assay throughput and decrease the amount of expensive reagents consumed. Microarray technologies are commonly used in fluorescence, electrochemical, and mass spectrometry analytical instruments. However, microarray technologies based on surface plasmon resonance (SPR), which is a powerful method used for the detection of molecular affinity and binding, have developed more slowly.

SPR imaging and detection of materials at metal interfaces and binding events on metal surfaces has been well described in the art, for example see J. M. Brockman, B. P Nelson, and R. M. Corn, “Surface Plasmon Resonance Imaging Measurements of Ultrathin Organic Films,” Ann. Rev. Phys. Chem. 2000, 51, 41-63. One of the determining factors of sensitivity in SPR imaging ellipsometry is the light source intensity of the system. The signal strength from the metal surface is linearly proportional to the incoming light strength, so a laser light source is preferred over LEDs and halogen lamps. However, expanding a spot Gaussian profile from a laser source using optical elements does not necessarily provide homogeneous illumination, which results in signal variation across the spot, i.e., sensing area. This requires a background correction that can limit the sensitivity of detection. This is particularly challenging for imaging larger areas by SPR, especially when within the larger areas there is a need for uniform detection, such as in a microarray. Therefore the is need for simpler and effective SPR sensing methods and instruments can image large areas with uniformity for use in bioanalytics, biopharmaceutics, and proteomics with relatively compact size at low cost.

### SUMMARY

One embodiment is a method of generating surface plasmon resonance using excitation light directed at a thin metal film by a micromirror. Another embodiment uses excitation light directed at a thin metal film by a micromirror scanner device. Another embodiment is a surface plasmon resonance imager comprising a micromirror that directs light to the surface of a thin metal film. Another embodiment is a method, comprising: a) directing light toward a thin metal film using a micromirror and b) detecting dynamic chemical events at or near the surface of the thin metal film. The dynamic events may be, for example, a fluidic change or a binding event. In many embodiments, directing light toward the thin film comprises using a micromirror scanner device.

### BRIEF DESCRIPTION OF THE DRAWINGS

FIG. 1 is a schematic of a surface plasmon resonance imager using a micromirror scanner device.

FIG. 2 is a schematic showing a flow cell for delivering sample to the thin film surface.

FIG. 3 is a schematic showing a metal film on a substrate.

FIG. 4 is a schematic of a surface plasmon resonance imager with both reflectance and emitted light detection.

FIG. 5 shows the contrast of one example of the surface plasmon resonance imager.

FIG. 6 shows the pixel resolution and uniformity of detection across the larger surface of one example of the surface plasmon resonance imager.

FIG. 7 shows the result of an experiment to determine the resolution of one example of the surface plasmon resonance imager.

### DETAILED DESCRIPTION

One embodiment is a method of generating surface plasmon resonance using excitation light directed at a thin metal film by a micromirror. Another embodiment uses excitation light directed at a thin metal film by a micromirror scanner device. In many embodiments, this method uses a single small spot or pixel of light generated by reflection or direction off of or from a micromirror or assembly of micromirrors. The spot or pixel may be scanned over a predetermined area by movement of the micromirror, which allows uniform detection over large and small surface areas. For an example of a micromirror scanner device, see U.S. Pat. No. 6,245,590; U.S. Pat. No. 6,362,912; U.S. Pat. No. 6,433,907; and U.S. Pat. No. 5,629,790. The thin metal film may be subdivided into a microarray. The microarray spots may be arranged in a variety of patterns. Other embodiments include various surface plasmon resonance sensors comprising a micromirror scanner device as a light source. Such system architecture allows for a low cost and simplistic design for an array based Surface Plasmon Resonance based analyzer for the detection of molecular binding events.

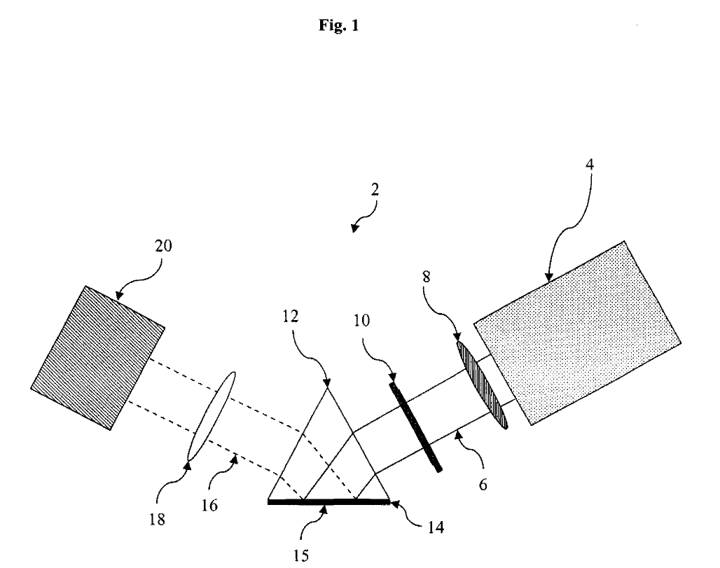

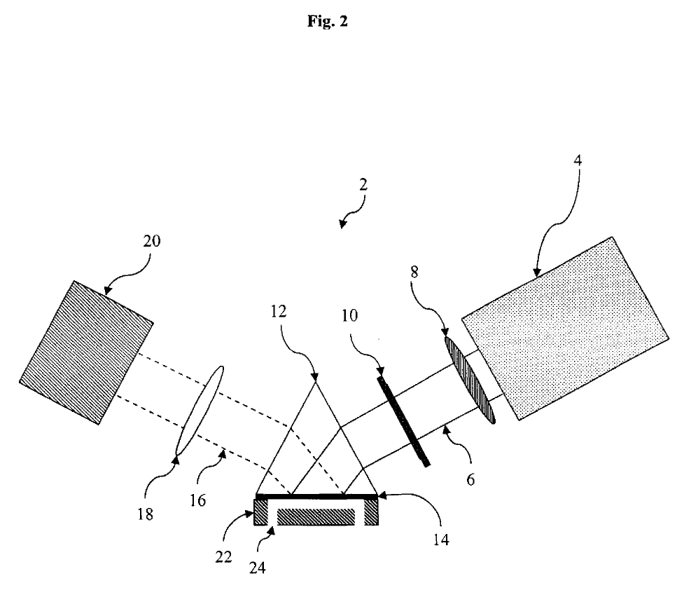

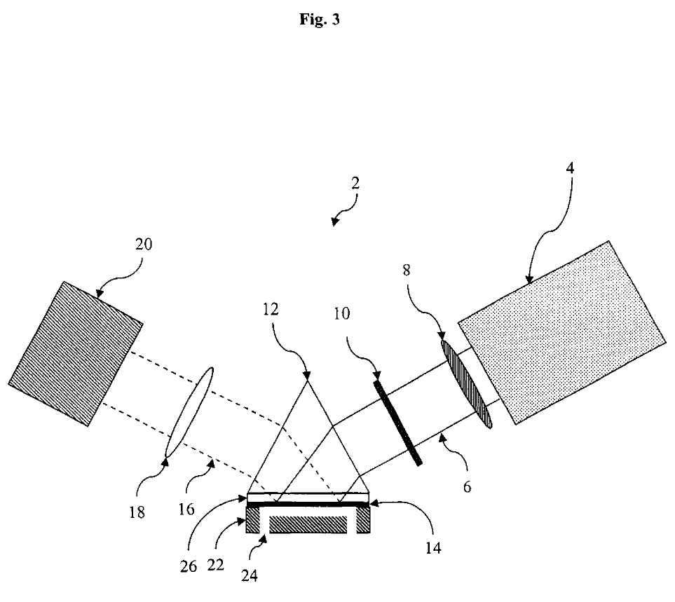

Another embodiment is a surface plasmon resonance imager comprising a micromirror that directs light to the surface of a thin metal film. The light may also pass through other optical elements, for example, a collimator, a polarizer, or a prism, before reaching the thin metal film. Referring to FIG. 1, one embodiment is a surface plasmon resonance imager (2), comprising: a) a micromirror scanner device (4); b) a collimator (8); c) a polarizer (10); d) a prism (12) that directs light (6) from the micromirror scanner device to a thin metal film (14) having a surface (15); d) an imaging lens (18); and e) a detector (20) that receives reflected light (16) from the thin metal film. The micromirror scanner device typically comprises a laser source, a microelectromechanical system (MEMS) micromirror that receives and reflects light from the laser source, and firmware to drive scanner movements the MEMS micromirror. Typically, the detector is a charge coupled device (CCD) camera. The sample and/or prism may be mounted on, for example, goniometers to vary the light angle with the surface and detect plasmon resonance angle shifts. Software may be designed, for example, to pick a pixel or groups of pixels form the surface, which is useful in the imaging of, for example, microarrays. The thin metal film may be deposited directly on the prism and may comprise, for example, Au, Ag, Cu, Ti, or Cr. The thin metal film may be subdivided into a microarray. A sample may be supplied the surface of the gold using, for example, referring to FIG. 2, a flow cell (22) having a channel for sample delivery (24). Referring to FIG. 3, the thin metal film may also be disposed on a substrate (26) through which passes the light from the micromirror scanner device. In these cases, one may wish to use an index matching fluid between the substrate and the prism as is known in the art.

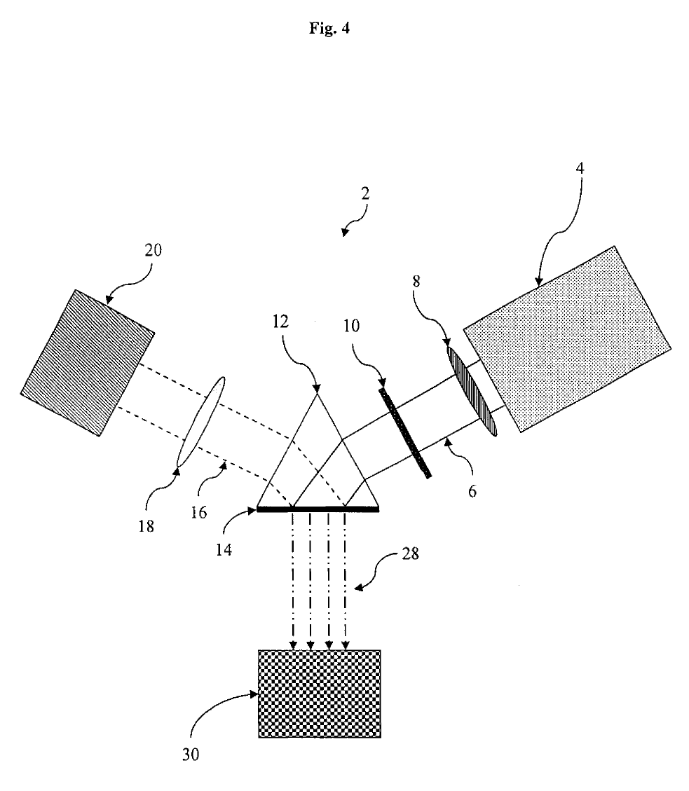

Surface plasmon resonance may also be used to excite molecules attached to or near the surface of the thin metal film, for example see T. Neumann, M. L. Johansson, D. Kambhampathi, and W. Knoll, “Surface-Plasmon Resonance spectroscopy,” Adv. Fun ct. Mater, 2002, 12(9), 575-586. Another embodiment is a surface plasmon imager as described above that further comprises, referring to FIG. 4, a detector (30) for receiving light from molecules attached to or near the surface of the thin metal film. This detector is typically a photomultiplier. Typically, there is an imaging lens and an interference filter between the molecules attached to or near the surface and the photomultiplier. Although FIG. 4 shows the detector for light (16) reflected from the surface, the instrument may also be used with only the detector (30) for receiving light from molecules attached to or near the surface of the thin metal film.

Another embodiment is a method, comprising: a) directing light toward a thin metal film using a micromirror and b) detecting dynamic chemical events at or near the surface of the thin metal film. The dynamic events may be, for example, a fluidic change or a binding event. In many embodiments, directing light toward the thin film comprises using a micromirror scanner device. In other embodiments, the detecting dynamic chemical events at or near the surface of the thin metal film comprises receiving light reflected from the thin metal film. In other embodiments, the detecting dynamic chemical events at or near the surface of the thin metal film comprises receiving light from molecules attached to from the thin metal film. In other embodiments, the detecting dynamic chemical events at or near the surface of the thin metal film comprises both receiving light reflected from the thin metal film and receiving light from molecules attached to from the thin metal film.

Dynamic chemical events that may be chemical bind events. Chemical binding events typically include chemical binding pairs. For example, the first component of the binding pair is immobilized on the thin metal film and the second component of the binding pair is bound to a chemical such as a protein. During the assay, the second component is introduced to the thin metal film by, for example, printing or solution flooding, which allows the second component to come into contact with the first component to initiate the binding event and produce a complex. The chemical binding pairs can include, for example, a biotin/avidin pair, a hapten/antibody pair, an antigen/antibody pair, a peptide-peptide pair, or complementary strands of DNA or RNA. In all embodiments, a third chemical component may bind the complex of the first component and second component. The first component can be immobilized by reaction with a first functional group bound to the microarray surface. The first functional group may be any chemical moiety that can react with the first component of the binding pair. Depending on the composition of the first component of the binding pair, the first functional group may include, for example, an amine, a carboxylic acid or carboxylic acid derivative, a thiol, a maleimide, biotin, a hapten, an antigen, an antibody, or an oligonucleotide. The first functional group itself may be bound to the surface of the microarray through a second functional group that forms a covalent bond with the spots of the microarray. In some embodiments, first functional group is biotin, the second functional group is a thiol, and the thin metal film comprises gold.

### EXAMPLES

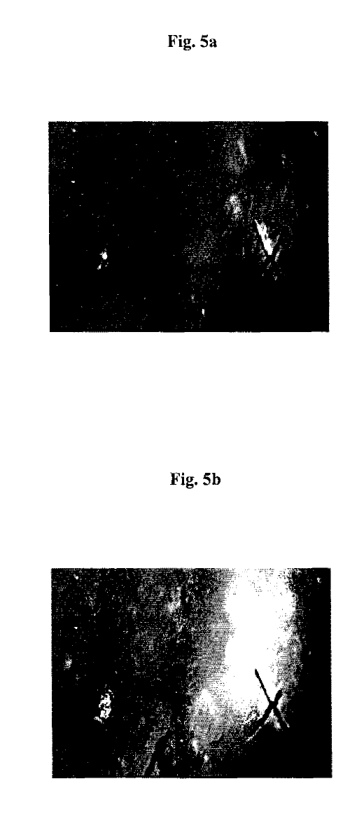

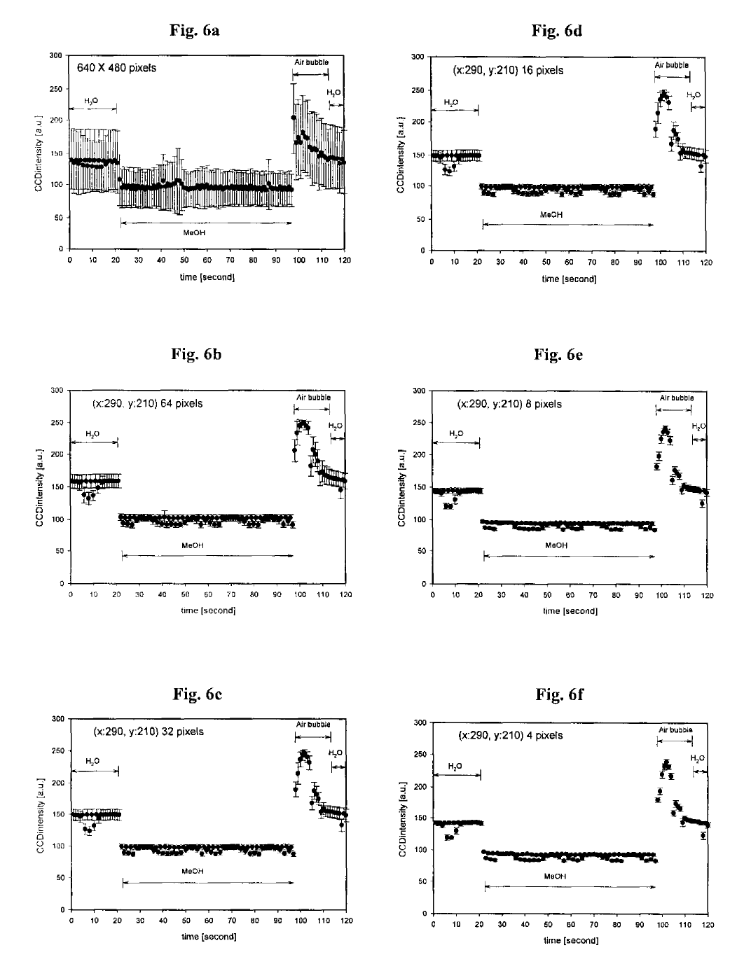

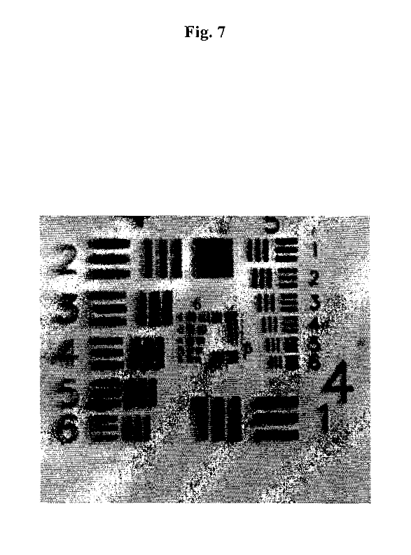

A surface plasmon resonance (SPR) sensing instrument using a Kretschmann configuration was constructed using a micromirror scanner device available from Microvision, Inc of Bothell, Wash. and described in U.S. Pat. No. 6,245,590; U.S. Pat. No. 6,362,912; U.S. Pat. No. 6,433,907; and U.S. Pat. No. 5,629,790. The micromirror scanner device is that used in the NOMAD product. The light source was a laser beam pigtailed in from the micromirror scanner device controller box unit had a wavelength of 658 nm. The laser beam carried a maximum power of 35 mW. The Krestschmann configuration prism coupler module included a prism made from high index material (Shott SF10 glass), a replaceable substrate, and a flow cell that carried solution under study. The substrate was made from the same material as the prism and was coupled with the prism through an index liquid matching fluid (Cargille labs, 1815Y) from the non-metallic coating side. The thin metal film on the substrate was gold with a thickness 47 nm. A flow cell with an o-ring gasket (18.5 mm O.D.) was pressed on the gold coated substrate forming a void that allowed the solvent exchange on the surface of the gold film. The small index change from the solution in contact with gold caused reflectivity change, and the area image is captured by a CCD/CMOS camera and the imaging files were recorded in a PC. The image recorded on the CCD/CMOS camera while water was in the flow cell is shown in FIG. 5a, and the image recorded after introduction of methanol is shown in FIG. 5b. The contrast of the images near the “X” reference point demonstrates the SPR sensing of the dynamic chemical event, in this case displacing of the water with methanol. FIG. 6a shows the CCD intensity across the 640×480 pixels shown in arbitrary units as a water-methanol-water exchange occurs. FIGS. 6b-f show the signal uniformity on going from 64, 32, 16, 8, and 4 pixels, respectively around the x:290, y:210 coordinates. This demonstrates the utility of the instrument for microarray applications. In a separate experiment, a USAF 1951 test target is used for evaluating the scanning SPR resolution. As shown in FIG. 7, the group 6 element 1 can be clearly defined, which gives 64 line pairs per millimeter, and a corresponding resolution of 15 μm. For a commercially available 1280 by 1024 pixels resolution CMOS camera, using 100 pixels (10 by 10) for each sampling spot, the setup in this example could cover more than 10,000 spots in a microarray. Typical microarray sizes are about 1 cm×3 cm.

Other embodiments are within the following claims.

1. A method, comprising: a) directing light toward a thin metal film using a micromirror to generate a surface plasmon and b) detecting dynamic chemical events at or near the surface of the thin metal film using surface plasmon resonance.

2. The method of claim 1, wherein the micromirror is 1000 microns to 100 microns in diameter.

3. The method of claim 1, wherein the micromirror is less than 250 microns in diameter.

4. The method of claim 1, wherein the micromirror is flexibly mounted on a substrate.

5. The method of claim 4, wherein the micromirror is controlled to scan the surface of the thin metal film.

6. The method of claim 5, wherein the thin metal film has an area of at least 1 cm².

7. The method of claim 6, wherein the surface of the thin metal film is divided into a microarray comprising a plurality of spots.

8. The method of claim 7, wherein the each spot of the microarray is surrounded by a hydrophobic composition.

9. The method of claim 8, wherein the hydrophobic composition is a self-assembled monolayer.

10. The method of claim 7, wherein at least one spot comprises a biopolymer bound to the surface of the thin metal film.

11. The method of claim 10, wherein the biopolymer is a polynucleotide, a polypeptide, or a polysaccharide.

12. The method of claim 7, wherein each spot size is at least 200 microns².

13. The method of claim 7, wherein the spot density is 500/cm².

14. The method of claim 1, wherein the thin metal film comprises Au, Ag, Cu, Ti, or Cr.

15. The method of claim 1, wherein the detecting comprises collecting light intensity changes from the surface plasmon resonance.

16. The method of claim 15, wherein a charge coupled device collects the light intensity changes.

17. The method claim 15, wherein the detecting further comprises collecting a fluorescent signal generated by the surface plasmon.

18. The method of claim 17, wherein a photomultiplier collects the fluorescent signal.
